(19) United States
(12) Patent Application Publication
(10) Pub. No.: US 2022/0400107 A1
(43) Pub. Date: Dec. 15, 2022

(54) MODIFYING A DOCUMENT OBJECT OF A GRAPHICAL USER INTERFACE TO PRESENT A TEMPORARY CREDENTIAL

(71) Applicant: Capital One Services, LLC, McLean, VA (US)

(72) Inventor: Anne MOSHYEDI, Potomac, MD (US)

(21) Appl. No.: 17/348,233

(22) Filed: Jun. 15, 2021

(51) Int. Cl. H04L 29/06; H04L 29/08; G06F 16/958

(52) U.S. Cl. CPC H04L 63/0846; H04L 67/306; G06F 16/986

(57) ABSTRACT

In some implementations, a device may detect that a page is associated with an entity and an exchange is associated with the entity. The device may modify a document used to generate the page to present a field associated with shared virtual identifiers to be displayed. The device may receive request information for a shared virtual identifier, the request information indicating one or more parameters associated with the shared virtual identifier, a first identifier associated with a first account, and a second identifier associated with a second account. The device may transmit, to a server device, the request information and exchange information associated with the exchange. The device may receive, from the server, presentation information that identifies the shared virtual identifier. The device may modify the document used to generate the page based on the presentation information to cause the shared virtual identifier to be provided for display.

### BACKGROUND

A graphical user interface is a form of user interface that allows users to interact with electronic devices. A web browser may provide a graphical user interface that presents web pages. A user may navigate to a web page by entering a web address into an address bar of the web browser and/or by clicking a link displayed via another web page. Navigation to a web page may consume resources of a user device on which the web browser is installed, may consume resources of a web server that serves the web page to the user device, and may consume network resources used for communications between the user device and the web server.

### SUMMARY

In some implementations, a non-transitory computer-readable medium storing a set of instructions for modifying a document object of a user interface to present a temporary credential includes one or more instructions that, when executed by one or more processors of a device, cause the device to: identify, based on information to be displayed by the user interface of the device, first information associated with an exchange, wherein the first information indicates an amount associated with the exchange and an entity associated with the exchange; modify the document object of the user interface to cause a temporary credential request field to be presented for display by the user interface, wherein the temporary credential request field indicates the first information and one or more fields for inputting account identifiers; receive, via an input to the temporary credential request field, a request to generate the temporary credential for the exchange, wherein the request indicates that the temporary credential is to be associated with a first account and a second account, and wherein the request indicates a first portion of the amount to be associated with the first account and a second portion of the amount to be associated with the second account; transmit, to a server device, second information associated with the request, wherein the second information indicates a first identifier of the first account, a second identifier of the second account, and the first information associated with the exchange; receive, from the server device, presentation information that indicates the temporary credential; modify the document object of the user interface based on the presentation information to cause an indication of the temporary credential to be provided for presentation via the user interface; and provide the user interface for presentation by the device based on modifying the document object.

In some implementations, a method of modifying a document used to generate a page to cause a shared virtual identifier to be presented for display by a device includes detecting, by a browser extension executing on the device, that the page is associated with an entity and an exchange associated with the entity; modifying, by the browser extension, the document used to generate the page to present a field associated with shared virtual identifiers to be displayed; receiving, by the browser extension, request information for the shared virtual identifier, the request information indicating one or more parameters associated with the shared virtual identifier, a first identifier associated with a first account, and a second identifier associated with a second account; transmitting, by the browser extension and to a server device, the request information and exchange information associated with the exchange; receiving, by the browser extension and from the server, presentation information that identifies the shared virtual identifier; modifying, by the browser extension, the document used to generate the page based on the presentation information, wherein modifying the document causes the shared virtual identifier to be provided for display via the page; and providing, by the browser extension, information to cause the page to be displayed based on modifying the document used to generate the page.

In some implementations, a system for generating multiple account (multi-account) temporary identifiers to enable an exchange to be associated with multiple accounts includes one or more memories and one or more processors, coupled to the one or more memories, configured to: receive a request to establish a multi-account temporary identifier, the request indicating a first identifier associated with a first account, a second identifier associated with the second account, and one or more parameters associated with the multi-account temporary identifier; determine whether the multi-account temporary identifier can be generated based on receiving approval from a device associated with at least one of the first account or the second account and based on attributes of the first account and attributes of the second account; generate, based on determining that the multi-account temporary identifier can be generated, the multi-account temporary identifier, wherein generating the multi-account temporary identifier includes creating a record in a database linking the first identifier, the second identifier, and the one or more parameters with the multi-account temporary identifier; receive, from a backend device associated with an entity, an indication of an exchange that was initiated using the multi-account temporary identifier; and approve the exchange if information associated with the exchange satisfies the one or more parameters, or deny the exchange if information associated with the exchange does not satisfy the one or more parameters.

### BRIEF DESCRIPTION OF THE DRAWINGS

FIGS. 1A-1D are diagrams of an example implementation relating to modifying a document object of a graphical user interface to present a temporary credential.

FIG. 2 is a diagram of an example environment in which systems and/or methods described herein may be implemented.

FIG. 3 is a diagram of example components of one or more devices of FIG. 2.

FIG. 4 is a flowchart of an example process associated with modifying a document object of a graphical user interface to present a temporary credential.

FIG. 5 is a flowchart of an example process associated with generating a temporary credential for multiple accounts.

### DETAILED DESCRIPTION

The following detailed description of example implementations refers to the accompanying drawings. The same reference numbers in different drawings may identify the same or similar elements.

Transaction terminals may be used to complete payment transactions at various vendor locations. In some cases, a group of users may place an order. For example, the group of users may sit at a table and place an order for a meal at a restaurant. A vendor employee may access a transaction terminal to generate and print one bill or receipt for a total payment for order, which may be presented to the group of users placing the order. In some cases, the vendor employee may be asked to split the receipt among users in the group of users. In this case, the vendor employee must then manually split the receipt into multiple receipts based on instructions from the users. The vendor employee may then manually interface multiple payment mediums (e.g., multiple transaction cards, or a combination of transaction cards, a check, and/or cash) with the transaction terminal to satisfy the total payment for the order. Manually splitting the receipt into multiple receipts and manually processing multiple transaction cards is both time and labor intensive. Moreover, relying on the vendor employee to accurately split the receipt into the multiple receipts and process the multiple transaction cards may lead to errors. For example, a user may erroneously pay for an item that was not ordered by the user or a wrong transaction card may be processed for a wrong amount. Further, processing multiple transactions for the single order consumes time and resources associated with completing each transaction for the order (e.g., the transaction terminal must communicate with a backend server to request approval for each transaction associated with the order).

As a transaction terminal may be capable of accepting only a single payment medium (e.g., a single transaction card) for a transaction, the request to approve the transaction from the vendor may identify only a single transaction card or a single account. Therefore, the backend server associated with the institution may be enabled to associate the transaction with only the single transaction card or the single account. To complete a transaction using multiple accounts, a user may be required to initiate multiple transactions at a transaction terminal (e.g., each transaction being initiated using a different transaction card or a different payment medium) to enable the transaction terminal to transmit separate requests to the backend server. This then enables the backend server to create multiple entries in a relational database linking the different transactions to different accounts. However, completing multiple transactions using multiple transaction cards or payment mediums consumes additional overhead associated with completing the multiple transactions. Moreover, completing multiple transactions using multiple transaction cards or payment mediums requires the backend server to settle multiple transactions with the vendor, creating additional complexity and additional overhead associated with settling the multiple transactions.

In some cases, the group of users may utilize a third party application or service to split the order (such as a payment application). For example, a single user from the group of users may present a payment medium (e.g., a transaction card, a check, or cash) to complete a single transaction for the order. The single user may then use the third party application or service to collect payments from the other users from the group of users to repay the single user for portions of the order. However, using the third party application or service requires that the single user coordinate with each of the other users after the single user has accepted a charge for the entire order. As a result, using the third party application or service is time and labor intensive as the single user may be required to determine a portion of the order to allocate to each other user, request a payment from each of the other users via the third party application or service, and wait for each of the other users to confirm the payment and transfer resources to the user via the third party application or service. Additionally, the user may be required to transfer resources from the third party application or service to an account that the user used to complete the transaction for the order. This consumes significant time and processing resources associated with requesting payments, receiving payments, and transferring the resources to another account. Moreover, in some cases, another user may deny or not complete the payment to the single user, resulting in the single user being responsible for the other user's portion of the order (e.g., as the single user has already paid for the entire order using resources associated with the user). Further, this requires a user to share sensitive information with the third party application or service, such as account information, an account number, and/or a routing number, among other examples. As a result, a security risk is introduced by the user sharing the sensitive information with the third party application or service.

In some cases, the group of users may utilize direct transfers to split a transaction or an order. For example, a first user may directly transfer resources to an account of the user that paid for the transaction or the order. However, this requires a user to share sensitive information with the other users, such as account information, an account number, and/or a routing number, among other examples. As a result, a security risk is introduced by the user sharing the sensitive information with the other users.

To address one or more of the problems described above, some implementations described herein enable a temporary credential to be generated for multiple, separate, accounts. For example, two or more accounts that are separate or independent (e.g., that are associated with different users) may be linked under a single temporary credential. The temporary credential may be used to initiate and/or complete one or more transactions. For example, a user may present or input the temporary credential at a transaction terminal. The transaction terminal may communicate with backend device(s) to confirm that the transaction can be completed using the temporary credential. As a result, the transaction terminal may view the transaction as a single transaction (e.g., associated with the temporary credential). However, a backend device associated with the two or more accounts (e.g., that are linked to the temporary credential) may be enabled to split the transaction among the two or more accounts.

For example, the backend device, when generating the temporary credential, may associate the temporary credential with one or more parameters. The one or more parameters may indicate terms of use for the temporary credential and/or limitations on a use of the temporary credential. For example, the one or more parameters may indicate a particular transaction (or transactions) that the temporary credential may be used to complete, may indicate one or more permissible entities (e.g., vendors or merchants) at which the temporary credential may be used to complete transactions, may indicate a limit or permissible amount that may be charged using the temporary credential, and/or may indicate an amount of time for which the temporary credential is valid, among other examples. In some implementations, the one or more parameters may indicate a split or portion of an amount of a transaction completed using the temporary credential that is to be allocated to each account linked with the temporary credential. For example, when the backend device receives an indication of a transaction completed using the temporary credential, the backend device may automatically allocate the amount of the transaction among the multiple accounts in accordance with the split or the portion.

As a result, the backend device may be enabled to settle a transaction associated with the temporary credential in a single event with an entity (e.g., with a merchant or a vendor) based on providing resources to the entity and identifying the temporary credential and/or a transaction identifier. Moreover, the backend device may be enabled to collect resources for the transaction from multiple user accounts. For example, the backend device may charge each account linked with the transaction identifier based on a portion of the transaction that is to be associated with the account. Additionally, the use of the temporary credential may enable the transaction to be completed in a single transaction without an entire amount of the transaction ever being charged or allocated to a single account. For example, as described above, previously if a single transaction were completed, then an entire amount of the transaction would be allocated or charged to an account associated with the payment medium used to complete the transaction. The use of the temporary credential may enable the backend device to approve and/or complete a single transaction (e.g., with an entity) and allocate portions of an amount of the transaction to multiple accounts, such that a full amount of the transaction is never charged or allocated to a single account.

Some implementations described herein enable the temporary credential to be presented at a relevant time. For example, to enable a temporary credential to be generated and presented to a user at a relevant time without requiring the user to navigate through a large number of web pages, some implementations described herein may enable a device to prompt a user to generate a temporary credential (e.g., to be associated with multiple accounts) at a relevant time (e.g., at a point of sale) via a user interface of the device. For example, the device may detect that a user interface is associated with (e.g., is displaying information associated with) a transaction associated with an entity (e.g., at a point of sale web page or at a transaction terminal). The device may identify transaction information (e.g., an entity associated with the transaction and/or a transaction amount) associated with the transaction. The device may prompt the user to generate a temporary credential to be linked with multiple accounts (e.g., the temporary credential be used for the transaction and/or for the transaction amount). The user may input, via the user interface, information (e.g., identifiers of other users or other account to be linked with the temporary credential) and/or other parameters to be associated with the temporary credential. The device may communicate with the backend device to cause the temporary credential to be generated (e.g., by the backend device) and presented for display via the user interface. For example, the device may insert code into a document object model of a web page or an application to make the temporary credential easier to access using a user device (e.g., by eliminating excessive web page navigation using the user device). As indicated above, some implementations described herein may conserve processing resources, memory resources, and network resources. Furthermore, the implementations described herein make data easier to access by enhancing a user interface, thereby improving a user experience, enhancing user-friendliness of a user device and the user interface, and improving the ability of a user to use the user device. In some implementations, temporary credential information is presented in a unified manner at a relevant time (e.g., at a point of sale) via a user interface (as opposed to a scenario where temporary credential information is presented on separate web pages of different platforms at irrelevant times), thereby further improving access to the temporary credential information. Additionally, some implementations described herein may improve data security by reducing a number of times that a user device transmits personal information of a user via a network.

As a result, the server device associated with the institution may be enabled to create a one-to-many relationship for a single transaction to simplify a process for splitting the transaction among multiple accounts. For example, some implementations described herein enable the transaction to be initiated and completed at a transaction terminal in a single transaction, thereby reducing a time and overhead that would have otherwise been used to split a transaction into multiple transactions and manually process multiple transaction cards. Moreover, some implementations described herein enable the server device to settle the transaction with the vendor in a single event using the transaction identifier. Further, some implementations described herein reduce a complexity and overhead that would have otherwise been required if a user were to use a third party application or service to collect resources for the transaction and transfer the resources to the account associated with the user that was used to complete the transaction.

Additionally, the use of a temporary credential may improve security for the accounts linked to the temporary credential. For example, the temporary credential may expire and/or may only be capable of being used in accordance with the one or more parameters associated with the temporary credential. Therefore, if a fraudulent or malicious actor were to obtain the temporary credential, the fraudulent or malicious actor may not be able to use the temporary credential for large transactions or unrelated transactions (e.g., unrelated to the purpose of the creation of the temporary credential). Moreover, the fraudulent or malicious actor may be unable to obtain information associated with the accounts linked to the temporary credential. For example, using the temporary credential to complete transactions may allow users to complete transactions without providing identifying information for accounts of the users. For example, the users may not be required to provide account numbers or transaction card numbers to complete the transaction. Rather, the backend device may be enabled to associate a transaction, completed using the temporary credential, with the multiple accounts (e.g., without identifying information of the multiple accounts being presented at a transaction terminal), as described in more detail elsewhere herein. As a result, the use of the temporary credential may improve security for the multiple accounts by reducing the number of times sensitive information (e.g., account numbers or transaction card numbers) is required to be provided to other users or third party services or entities (e.g., thereby reducing a likelihood that a fraudulent or malicious actor may obtain the account information via the other users or the third party services or entities).

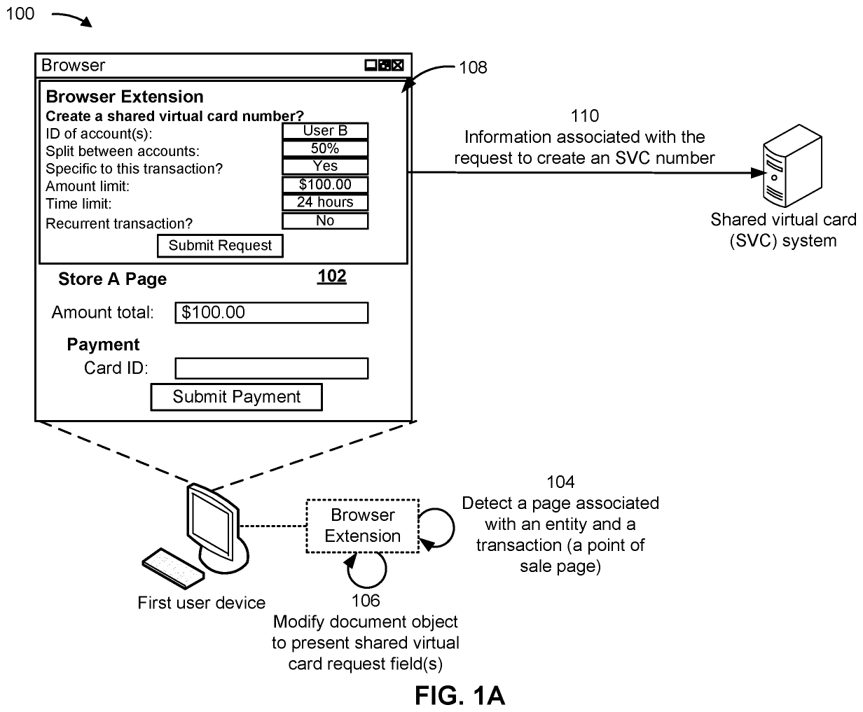

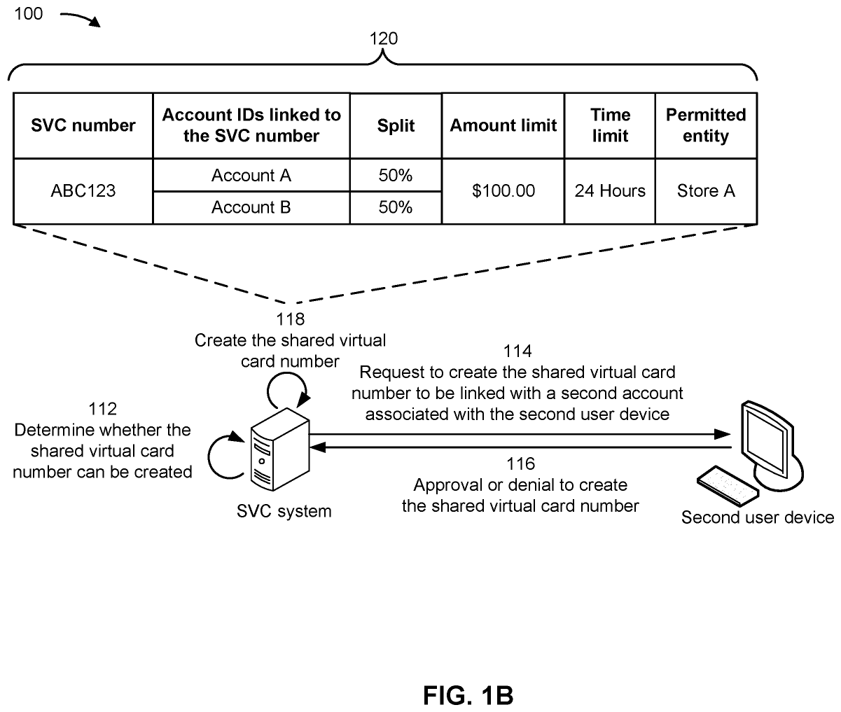

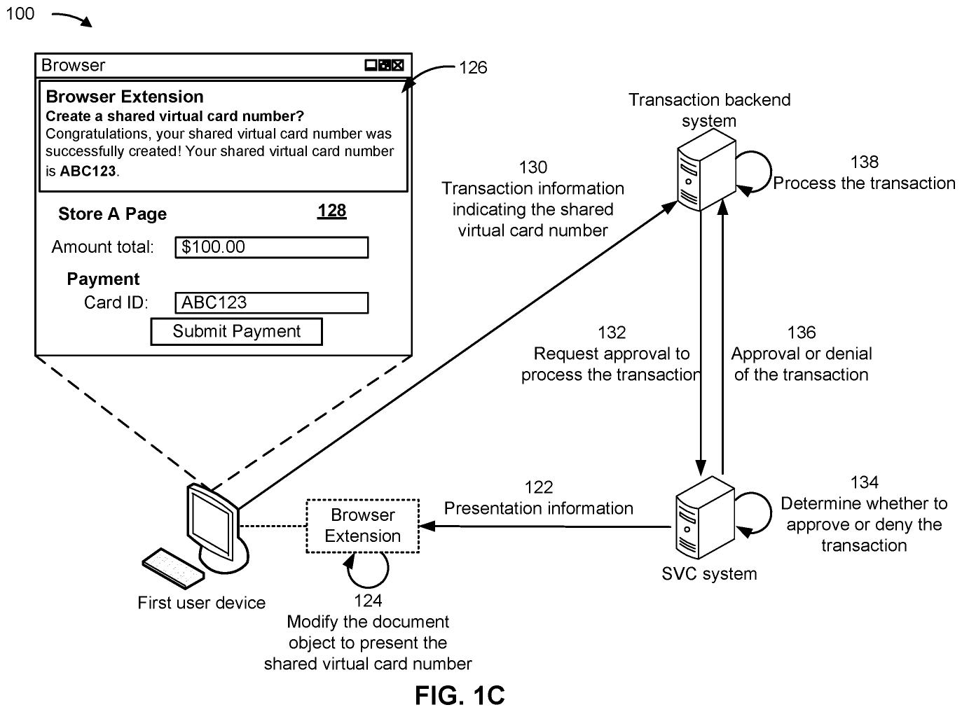

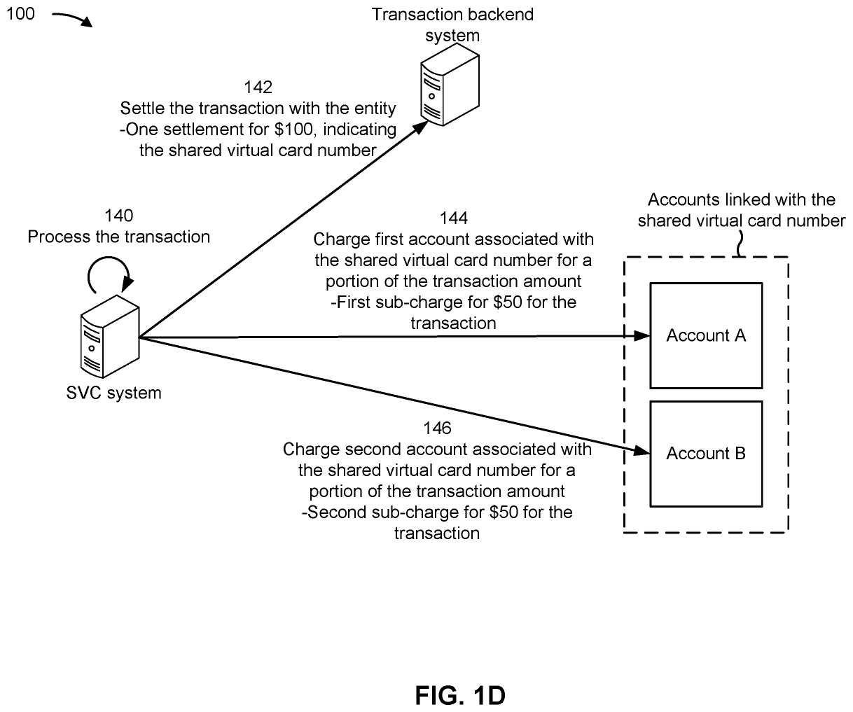

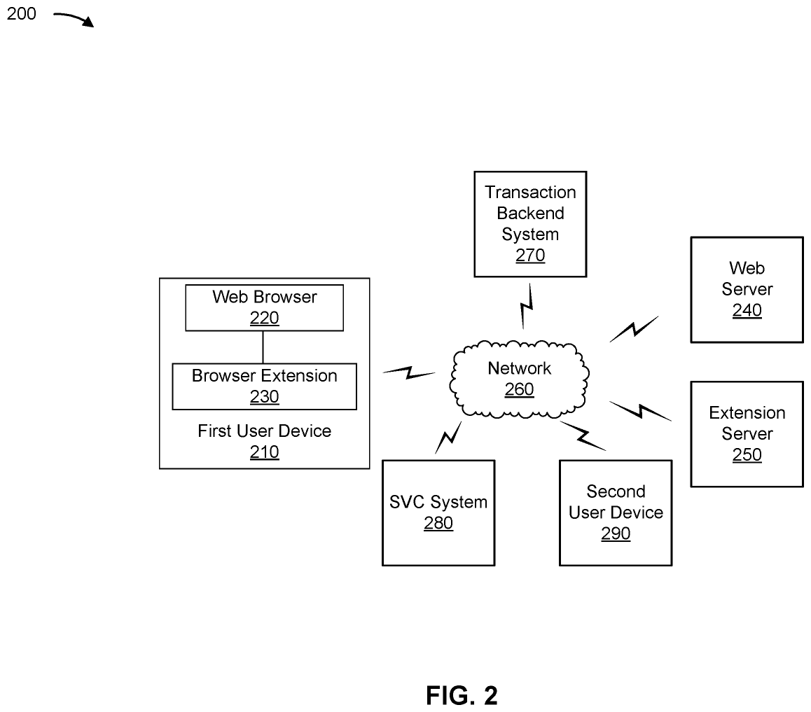

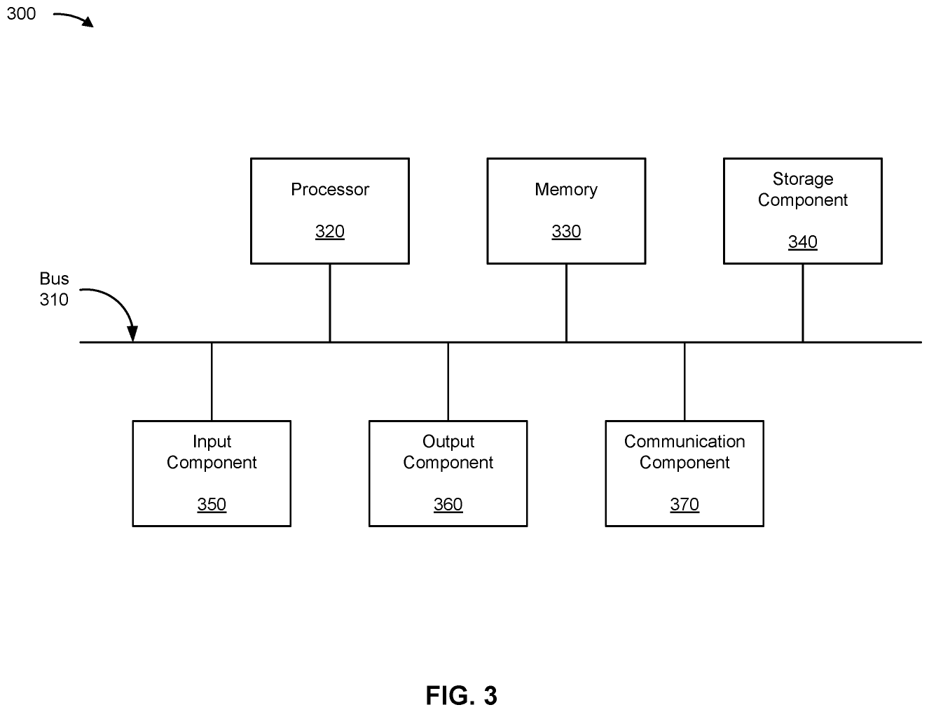

FIGS. 1A-1D are diagrams of an example 100 associated with modifying a document object of a graphical user interface to present a temporary credential. As shown in FIGS. 1A-1D, example 100 includes a first user device, a shared virtual card (SVC) system, a second user device, and/or a transaction backend system. The first user device and/or the second user device may each execute a web browser and/or a browser extension. These devices are described in more detail in connection with FIGS. 2 and 3.

As used herein, “SVC” or “SVC number” may refer to a temporary credential that is associated with, or linked with, multiple independent accounts. The temporary credential may be an identifier generated to be used as a substitute for an actual transaction card number. For example, an SVC number may be a temporary credential, a virtual card number, a virtual account number, a unique identifier, and/or a pseudo card number, among other examples. As used herein, “SVC” or “SVC number” may be referred to as a virtual card (or virtual card number), a temporary credential, a shared virtual identifier, a multiple account (multi-account) temporary identifier, and/or a shared unique identifier, among other examples. For example, an SVC number may be a single use or a multi-use number that may be used to complete one or more transactions, so long as information associated with the transaction satisfies one or more parameters associated with the SVC number, as explained in more detail elsewhere herein. A transaction may be referred to herein as an exchange, an electronic exchange, a transfer, an event, a sale, a purchase, and/or other similar terms.

As shown in FIG. 1A, a user may interact with the first user device, that executes the web browser and the browser extension, to initiate a transaction with an entity. For example, as shown by reference number 102, the user may navigate to a web page associated with the entity and select one or more products or services to purchase. The web page may be a point of sale page (e.g., a checkout page or another web page associated with a point of sale) or the first user device may be displaying a page associated with an application executing on the first user device, among other examples. For example, the web page may indicate transaction information (e.g., products and/or services to be purchased and/or a transaction amount) and/or one or more fields for the user to input identifiers for a transaction card (e.g., a credit card or a debit card) or a gift card. In some implementations, the browser extension may request access to web page information for the purposes of identifying transaction information and/or generating temporary identifiers. The user may provide an input to the first user device granting the browser extension access to web page information.

As shown by reference number 104, the browser extension (or the first user device) may detect that the web page is associated with an entity and a transaction (e.g., the browser extension may detect that the web page is a point of sale page or a checkout page). For example, the browser extension may analyze information associated with the web page to identify the entity and/or identify that the web page is a point of sale page. In some implementations, the browser extension may detect that the web page accepts cards as a form of payment (e.g., based on detecting a field in which a card identifier (e.g., a card number) can be input to complete the transaction).

For example, the browser extension (or the first user device) may identify, based on information to be displayed by the user interface of the device, information associated with a transaction (e.g., transaction information), such as a transaction amount, an entity (e.g., a merchant or vendor associated with the entity), one or more products or services associated with the transaction, and/or a transaction date, among other examples. For example, the browser extension may extract or identify the transaction information based on the information being presented for display on the web page (e.g., via the first user device). The browser extension (and/or the first user device) may identify this point of sale information from the web page, a document used to generate the web page (e.g., a document object model (DOM) and/or a hypertext markup language (HTML) document), and/or a uniform resource locator (URL) of the web page, such as by parsing the web page, DOM, or URL for keywords, by extracting information from a particular field, information element, or portion of the web page, DOM, or URL, and/or identifying the point of sale information based on a URL of the web page (e.g., by looking up a merchant, product, or other point of sale information stored in a data structure in association with the URL), among other examples.

Although the example above (and other examples described herein) are described with respect to a web browser and a browser extension executing on the first user device, other examples are also contemplated. For example, an application may be executing on the second client device. The application may display a point of sale page in a similar manner as the web page described above. Alternatively, the first user device may not be displaying any transaction information and/or web pages and the first user device may cause an SVC request field to be displayed (e.g., as explained in more detail elsewhere herein) without the browser extension (or the first user device) detecting transaction information.

As shown by reference number 106, the first user device (or the browser extension) may modify a document used to generate the web page (e.g., a DOM) by inserting code into the document to cause an SVC request field (as shown by reference number 108) to be displayed (e.g., via the user interface of the first user device). In some implementations, the first user device (or the browser extension) may modify the document used to generate the web page based on detecting the transaction information (e.g., as described above). Additionally, or alternatively, the first user device (or the browser extension) may modify the document used to generate the web page based on a request received via a user input. In some implementations, the first user device may display the SVC request field based on the user navigating to a web page or executing an application associated with the SVC request field (e.g., the SVC request field may not be displayed via the browser extension and/or on a point of sale page in some implementations).

For example, the code inserted into the document (e.g., the DOM) may be based on SVC request field information stored by the first user device and/or the browser extension. The SVC request field information may include transaction information, an entity associated with a transaction, and/or one or more parameters that may be associated with an SVC, among other examples. The code may include HTML code, cascading style sheet (CSS) code, a script, or any other code capable of causing the web page to present information. After the code is inserted, the first user device may provide the web page for presentation and/or may present the web page for display. Insertion of the code may cause the web page to be presented differently than if the web page were presented without the code.

For example, as shown by reference number 108, the code may cause one or more fields to be displayed by the first user device. The one or more fields may include an account identifier field (e.g., “ID of account(s)”) that enables identifiers of users and/or accounts, that are to be linked to an SVC, to be input into the account identifier field. An input to the account identifier field may be a unique identifier associated with a user or an account to be linked with the SVC. For example, the unique identifier associated with an additional account may be an identifier associated with a user that is associated with the additional account. For example, the unique identifier may not indicate sensitive information associated with the additional account, such as an account number and/or a routing number, among other examples. In some implementations, the unique identifier may be selected from a list or database of unique identifiers. For example, the SVC system may maintain a list or database of unique identifiers that links each unique identifier to an account. The SVC system may transmit, to the first user device, an indication of the unique identifiers. The user may identify a unique identifier associated with a user based on the list or database provided to the first user device. For example, another user may share a unique identifier associated with the other user (e.g., and an account associated with the other user) with the user to enable the user to request that the SVC be linked with the account associated with the other user.

In some implementations, the first user device may receive, store, and/or display a list of approved unique identifiers available for the user to select for a request to generate an SVC. For example, the first user device and other user devices (and/or the SVC system) may communicate to request and/or approve permission to be added to a list of available users for the user to select for a request to generate an SVC. For example, the first user device may transmit, to the second user device (via the SVC system in some implementations), a request for permission to make a unique identifier associated with a user of the second user device available for the user to select for a request to generate an SVC. If the second user device transmits an approval of the permission, then the unique identifier associated with a user of the second user device (e.g., “User B”) may be added to a list of approved unique identifiers available for the user to select for a request to generate an SVC. Therefore, in some implementations, when selecting a unique identifier to be associated with the request to generate an SVC, only unique identifiers included in the list of approved unique identifiers may be selected by the user of the first user device. This may improve security and reduce fraudulent requests by ensuring that a user has permission to request to generate an SVC with another user prior to the user submitting the request.

In some implementations, the first user device may search for other users based on personally identifiable information associated with the other users. For example, the first user device may search for a unique identifier associated with a user using a phone number associated with the user, an e-mail associated with the user, a name of the user, a username associated with the user, and/or a unique code or number associated with the user, among other examples. The first user device may identify the unique identifier associated with the user (and associated with an account of the user) based on searching for the user (e.g., in a database provided by the SVC system). In some implementations, the first user device may add the unique identifier to a list of unique identifiers stored by the first user device (e.g., to enable the user of the first user device to quickly identify a unique identifier included in the list).

The one or more fields may include a split information field (e.g., “Split between accounts”) that enables information to be input that indicates a split or a portion to be allocated to each account associated with the SVC. For example, the split or portion may indicate a percentage (e.g., “50%”) to be associated with each (or a particular) account to be linked to the SVC. As another example, the split or portion may indicate an amount (e.g., “$50.00”) to be associated with each (or a particular) account to be linked to the SVC. For example, a single value may be indicated for the split information field (e.g., a single percentage or a single amount) indicating that each account to be linked to the SVC is to be associated with the single value. As another example, the split information field may enable a value to be input for each account to be linked to the SVC.

The one or more fields may include a field for indicating whether the SVC is to be specific to one or more transactions (e.g., “Specific to this transaction?”). For example, the SVC may be generated such that the SVC may be used only for a specific transaction or a specific set of transactions. Alternatively, the SVC may be generated such that the SVC may be used in any transaction, so long as transaction information associated with the transaction satisfies one or more parameters of the SVC (e.g., as indicated by values input into the one or more fields). For example, an input of “Yes” to the “Specific to this transaction?” field may indicate that the SVC is to be associated with only a single transaction (e.g., the transaction being displayed by the first user device) or a set of transactions. An input of “No” to the “Specific to this transaction?” field may indicate that the SVC may be used to complete any transactions, subject to other parameters associated with the SVC, as described in more detail elsewhere herein.

The one or more fields may include an amount limit field (e.g., “Amount limit”) to enable a maximum amount that may be charged using the SVC to be input. For example, the SVC may be associated with an amount limit. If the SVC is used to complete a transaction that is associated with an amount greater than the amount limit, then the transaction may be denied or declined. The one or more fields may include a time limit field (e.g., “Time limit”) to enable an amount of time during which the SVC is to be active or valid to be input. For example, the SVC may be generated such that the SVC may only be used for the amount of time input into the time limit field (e.g., “24 hours”). After an expiration of the amount of time input into the time limit field, the SVC (e.g., an identifier of the SVC) may no longer be active or valid, such that the SVC may not be used to complete transactions after the expiration of the amount of time. In some implementations, the amount limit field and/or the time limit field may have values that are automatically input (e.g., by the browser extension and/or the first user device) based on an input to the field for indicating whether the SVC is to be specific to one or more transactions. For example, an input to the amount limit field may be automatically input as a transaction amount of a transaction if the input to the “Specific to this transaction field?” indicates that the SVC is to be specific to the transaction.

The one or more fields may include one or more recurrent transaction fields (e.g., “Recurrent transaction?”) to enable recurrence information associated with the SVC to be input. For example, recurrence information may indicate information associated with repetitions of future transactions or events to be associated with the SVC. For example, in some implementations, an event or a transaction may be reoccurring or periodic, such as for a monthly bill or a subscription. Therefore, each event may be associated with a similar split among multiple accounts. For example, users living in the same house may wish to split a utility bill among accounts associated with the users each month. Therefore, when submitting an initial request to generate an SVC, a user may indicate recurrence information such that future similar transactions are associated with the SVC in a similar manner. The recurrence information may include an identifier of the transaction, an identifier associated with one or more accounts (e.g., a unique identifier of a user associated with an account), a portion of an amount of the event to be associated with one or more additional accounts, and/or periodic information (e.g., information indicating a periodicity of events, such as weekly, bi-monthly, monthly, every six months, yearly, or another period), among other examples. For example, the recurrence information may indicate a periodicity indicating time periods during which the SVC is to be valid. This may enable the SVC system to generate an SVC and to split future events or future transactions (identified based on the recurrence information) among the accounts linked with the SVC without the SVC system receiving an additional request to generate an SVC. This may conserve resources that would have otherwise been used to transmit a request to generate an SVC each time the event occurs or is completed (e.g., each time the periodic or recurring transaction is completed).

The first user device (and/or the browser extension) may receive an indication of parameters to be associated with the SVC via information input to the one or more fields. For example, the first user device (and/or the browser extension) may receive, via an input to the SVC request field, a request to generate the SVC, where the request indicates that the SVC is to be associated with a first account (e.g., associated with a user of the first user device) and one or more other accounts. In some implementations, the request may indicate a portion of the amount of the transaction (or of transactions completed using the SVC) to be associated with the first account and other portions of the amount of the transaction (or of transactions completed using the SVC) to be associated with the one or more other accounts. In some implementations, the first user device (and/or the browser extension) may receive an indication of one or more parameters associated with the request (e.g., indicating limits or terms of use of the SVC). For example, as described elsewhere herein, the one or more parameters may include an amount of time that the SVC is to be valid, an amount limit associated with the multi-account temporary identifier, one or more permitted entities associated with the SVC, whether the SVC is capable of being used to complete multiple transactions other than only specified transactions, and/or recurrence information associated with the SVC, among other examples.

As shown by reference number 110, the first user device (and/or the browser extension) may transmit, and the SVC system may receive, information associated with the request to create an SVC (e.g., an SVC number). For example, the first user device (and/or the browser extension) may transmit an indication of the request to create the SVC, an indication of accounts to be linked with the SVC, and/or an indication of the one or more parameters to be associated with the SVC, among other examples. For example, the first user device (and/or the browser extension) may transmit, and the SVC system may receive, a request to establish the SVC. The request may indicate identifiers of accounts to be linked with the SVC (e.g., may indicate the unique identifiers of users associated with the accounts to be linked with the SVC), and may indicate the one or more parameters to be associated with the SVC, among other examples. In some implementations, the request may indicate information associated with a transaction (or a set of transactions) to be associated with the SVC.

As shown in FIG. 1B, and by reference number 112, the SVC system may determine whether the SVC number can be created based on the request received by the SVC system. In some implementations, the SVC system may determine if the account associated with the request (e.g., the account associated with the first user device) and/or the one or more additional accounts indicated by the request are valid. For example, the SVC system may determine if the account and/or one or more additional accounts are real and/or active accounts associated with an institution associated with the SVC system.

In some implementations, the SVC system may perform, based on receiving the request to create the SVC and using a fraud model, a fraud analysis to determine a fraud score associated with the request. For example, the SVC system may determine the fraud score based on a location of the first user device (e.g., if the first user device is located a large distance from a location of the transaction or a location of another user device, then the SVC system may determine a higher likelihood of fraud), a number of requests made by the first user device (or a user associated with the first user device) (e.g., a higher number of requests (e.g., within an amount of time) may indicate a higher likelihood of fraud), a number of previous requests made by the first user device, an amount limit associated with the SVC, and/or the portion(s) indicated by the request (e.g., allocating all or a majority of an amount of a transaction to another account may indicate fraud), among other examples. The SVC system may use one or more (or all) of the factors described above as an input to the fraud model. The fraud model may output the fraud score (e.g., the fraud model may be a machine learning model). In some implementations, a determination of whether the request is valid may be based on the fraud score. For example, if the fraud score is greater than or equal to a threshold value, then the SVC system may determine that the request is fraudulent and is therefore not valid. If the fraud score is less than the threshold value, then the SVC system may determine that the request is not fraudulent and therefore may be valid.

In some implementations, the SVC system may determine if an account indicated by the request is capable of accepting the portion of the amount to be allocated to the account by the request based on one or more attributes (e.g., a credit limit, an account balance, and/or a remaining balance, among other examples) associated with the account. For example, the SVC system may determine a portion of an amount of a transaction (or a portion of a maximum amount that can be charged using the SVC) to be associated with the account based on splitting information indicated by the request to generate the SVC. For example, if the maximum amount that can be charged using the SVC is $100.00 and the portion indicated by the request is 25%, then the SVC system may determine if the account is capable of accepting a charge for $25.00 (e.g., 25% of $100.00). An account may be capable of accepting an amount or a charge if an account balance or a credit limit associated with the account is greater than or equal to the portion. For example, the SVC system may determine whether the account balance or the credit limit associated with the account is greater than or equal to $25.00. If the additional account is capable of accepting the portion of the amount that the SVC is capable of charging (e.g., as indicated by the request), then the SVC system may determine that the request is valid for that account. The SVC system may perform similar determinations for each account indicated by the request to generate the SVC.

As shown by reference number 114, the SVC system may transmit, and the second user device may receive, an indication of the request to generate the SVC to be linked with an account associated with the second user device. For example, the account associated with the second user device may be an account indicated by the request to generate the SVC. The SVC system may transmit an indication of the request to generate the SVC to user devices associated with each account indicated by the request and/or user devices associated with each account for which the request is valid, as determined by the SVC system.

In some implementations, the indication of the request to generate the SVC with an account associated with the second user device may be an approval request associated with the request to generate the SVC. For example, the SVC system may transmit, to the second user device, an approval request to generate the SVC to be linked with the account associated with the second user device. In some implementations, the approval request may be transmitted via a text message, a voice message, and/or an e-mail, among other examples. In some implementations, the transmission of the approval request may cause a notification of the approval request to be provided by the second user device (e.g., the second device may provide haptic feedback and/or may display an indication of the notification).

In some implementations, the approval request may indicate a portion of transaction amounts of transactions completed using the SVC that are to be associated with the account and/or other information associated with the SVC. For example, the approval request may identify one or more parameters associated with the SVC, such as an amount limit, a time limit, one or more permitted entities, and/or recurrence information, among other examples. For example, if the second user device is associated with “User B,” then the approval request may indicate a portion of transaction amounts of transactions completed using the SVC that are to be associated with the account associated with the “User B” (e.g., 50%).

The second user device may receive an indication of whether the request is granted for the account associated with the second user device. For example, a user associated with the second user device may review the approval request and may provide an input indicating whether the request to generate the SVC is approved or denied for the account associated with the second user device. In some implementations, the second user device may receive an indication of a modified request to generate the SVC (e.g., based on an input provided by the user associated with the second user device). For example, the modified request may change or modify a value of one or more parameters indicated by the request and/or may add an additional parameter to be associated with the SVC. In such examples, the SVC system may transmit, to the first user device, an approval request for the modified request to generate the SVC, in a similar manner as described in connection with transmitting the approval request to the second user device. As a result, the SVC system may enable a negotiation between the first user device and the second user device to determine the one or more parameters to be associated with the SVC.

As shown by reference number 116, the second user device may transmit, and the SVC system may receive, an indication of whether the request is granted for the account associated with the second user device. The SVC system may receive indications of whether the request is granted for one or more (or all) accounts indicated by the request to generate the SVC. In some implementations, the SVC system may determine that the request is denied for an account if the SVC system has not received a response to an approval request within a threshold amount of time. In some implementations, the SVC system may transmit, and the first user device may receive, an indication of additional accounts for which the request to generate the SVC has been denied. In some implementations, the SVC system may transmit, and the first user device may receive, an indication of whether the request to generate the SVC with one or more accounts is approved. For example, the SVC system may receive, from a user device (such as the second user device), an indication that the request to generate the SVC has been denied for an account. The SVC system may transmit, to the first user device, an indication that the request to generate the SVC has been denied for the account. In some implementations, if the request to generate the SVC is denied for any account indicated by the request, then the SVC system may cancel the request and/or may refrain from continuing to process the request.

As shown by reference number 118, the SVC system may create the SVC number based on the request and/or based on determining that the SVC can be generated (e.g., as described in more detail elsewhere herein). In some implementations, the SVC system may generate the SVC number based on a protocol or system for generating random and/or unique identifiers. The SVC system may generate or create the SVC number based on receiving or obtaining approval to generate the SVC number from one or more devices associated with one or more (or all) accounts to be linked with the SVC number. As shown by reference number 120, the SVC system may generate an entry or a record in a database (e.g., a relational database) that links the SVC number (e.g., “ABC123”) with multiple accounts (e.g., “Account A” and “Account B”). For example, the “Account A” may be an account associated with a user of the first user device (e.g., that transmitted the request to generate the SVC) and the “Account B” may be associated with a user of the second user device (e.g., that transmitted the approval of the request to generate the SVC). In some implementations, the record in the database may link the SVC number with the identifiers of the multiple accounts and with an indication of the one or more parameters associated with the SVC. For example, as shown in FIG. 1B, the record in the database may link the SVC number with an indication of a portion of amounts associated with the SVC to be allocated to each account of the multiple accounts (e.g., 50% to be allocated with “Account A” and 50% to be allocated to “Account B”), an amount limit (e.g., “$100.00”), a time limit (e.g., “24 hours”), and/or one or more permitted entities (e.g., “Store A”). Linking the SVC number with the one or more parameters in the database may enable the SVC system to quickly and easily determine whether a transaction that is initiated using the SVC number should be approved or denied (e.g., based on whether transaction information of the transaction satisfies the one or more parameters, as explained in more detail elsewhere herein).

In some implementations, based on generating the SVC number, the SVC system may modify an account balance, or a credit limit, associated with the accounts linked with the SVC. For example, generating the SVC number may enable the SVC to be used to complete one or more transactions (e.g., the transaction(s) linked with the SVC and/or transactions up to an amount limit associated with the SVC). Therefore, to ensure that the accounts linked with the SVC do not incur charges such that the account would not be capable of accepting an amount of a transaction completed using with the SVC, the SVC system may reduce an available balance or a credit limit of the accounts linked with the SVC by a portion of the maximum amount that can be charged using the SVC. For example, the SVC system may reduce a spending limit associated with a first account (e.g., “Account A”) by a first portion (e.g., 50%) of an amount limit associated with the SVC number (e.g., “$100.00) indicated by the one or more parameters. Therefore, the SVC system may reduce a spending limit associated with the first account by $50.00 (e.g., 50% of $100.00), as $50.00 is the maximum amount that could be allocated to the first account based on one or more transactions completed using the SVC. Similarly, the SVC system may reduce a spending limit associated with a second account (e.g., “Account B”) by a second portion (e.g., 50%) of the amount limit associated with the SVC number (e.g., “$100.00) indicated by the one or more parameters. Therefore, the SVC system may reduce a spending limit associated with the second account by $50.00 (e.g., 50% of $100.00), as $50.00 is the maximum amount that could be allocated to the second account based on one or more transactions completed using the SVC. This may reduce a complexity associated with processing transactions associated with the SVC because the SVC system may not be required to determine if each account linked with the SVC number has a sufficient balance or credit limit when processing the transaction. In some implementations, after the SVC is expired or no longer active (e.g., after an amount of time indicated by the time limit), the SVC system may remove a balance of any unused credit from the accounts linked with the SVC number. In other words, when generating the SVC number, the SVC system may place a hold on each account linked with the SVC number for a maximum amount that could be allocated to each account based on one or more transactions completed using the SVC. After the SVC is expired or no longer active, the SVC system may remove or release the holds on the accounts linked with the SVC number.

In some implementations, the SVC system may not modify an account balance, or a credit limit, associated with the accounts linked with the SVC based on generating the SVC number. For example, rather than reducing an available balance or a credit limit of the accounts linked with the SVC by a portion of the maximum amount that can be charged using the SVC at the time the SVC number is generated, the SVC system may not modify the available balance or the credit limit of the accounts linked with the SVC. Rather, the SVC system may determine whether to reduce an available balance or a credit limit of the accounts at the time a transaction is initiated using the SVC number. This may enable the SVC system to not place unnecessary holds on the accounts linked with the SVC number (e.g., because the maximum amount that can be charged, to a particular account, using the SVC may never actually be charged to complete one or more transactions).

As shown in FIG. 1C, the SVC system may transmit, to the first user device (and/or the second user device) an indication of the SVC number generated by the SVC system. For example, as shown by reference number 122, the SVC system may transmit, and the first user device (and/or the browser extension) may receive, presentation information that indicates or identifies the SVC number. As shown by reference number 124, the browser extension may modify the document used to generate the web page (e.g., a DOM) by inserting code into the document that is based on the presentation information. After the code is inserted, the second client device may provide the web page for presentation and/or may present the web page for display. For example, as shown by reference number 126, the browser extension may modify the document (e.g., the DOM) to cause an indication that the SVC number was successfully created and an indication of the SVC number (e.g., “ABC123”) to be displayed by the first user device. As described above, in some implementations, a browser extension may not be used, and the first user device may simply receive an indication of the SVC number and/or cause the SVC number to be displayed by the first user device. As shown by reference number 128, in some implementations, the code may cause the SVC number (e.g., “ABC123”) to be inserted in a relevant field of a point of sale page being displayed by the first user device (e.g., in a card identifier field of a checkout page).

In some implementations, when the SVC number is associated with a particular transaction (e.g., such that the SVC number was generated and approved for a particular transaction), the first user device and/or the browser extension may perform an action to ensure that a transaction is not completed using the SVC number that is different than the particular transaction associated with the SVC number. For example, the first user device (and/or the browser extension) may detect, based on information being displayed by the user interface of the device and after receiving the presentation information, a modification associated with the transaction such that one or more items or products associated with the transaction is changed and/or such that an amount associated with the transaction is modified (e.g., to a modified amount), among other examples. In other words, the first user device (and/or the browser extension) may detect that transaction information on the payment page and/or the checkout page being displayed by the first user device no longer matches the transaction information for the particular transaction linked with the SVC number.

In response, the first user device (and/or the browser extension) may perform an action to prevent the transaction from being submitted or initiated using the SVC number. For example, the first user device (and/or the browser extension) may modify the document object of the user interface to prevent the SVC number from being used for the transaction based on detecting the modification. For example, the first user device (and/or the browser extension) may prevent a “submit” button or a similar button from being selected by a user. As another example, the first user device (and/or the browser extension) may prevent information from being input into the “card identifier” field (or a similar field). In some implementations, after receiving the presentation information, the first user device (and/or the browser extension) may prevent modifications to the transaction information being displayed by the user interface. In this way, the first user device (and/or the browser extension) may prevent the SVC number from being used to initiate transactions other than the particular transaction linked with the SVC number. This may conserve resources that would have otherwise been used transmitting an indication of the transaction (e.g., to the transaction backend system), processing the transaction (e.g., by the transaction backend system), transmitting a request for approval of the transaction (e.g., from the transaction backend system to the SVC system), determining that the transaction should be denied (e.g., by the SVC system), and transmitting the indication that the transaction is denied (e.g., by the SVC system and by the transaction backend system).

As shown by reference number 130, the first user device (or another device, such as a transaction terminal) may transmit, and the transaction backend system may receive, transaction information indicating the SVC number. The transaction backend system may be associated with an entity. A transaction may be initiated with the entity by providing or presenting the SVC number (e.g., by inputting the SVC number in a payment or checkout page or by presenting or inputting the SVC number at a transaction terminal). For example, the first user device may receive, via the user interface, a request to initiate the transaction using the SVC number. The first user device may transmit, to the transaction backend system, information that indicates the SVC number and the transaction information associated with the transaction. As shown by reference number 132, the transaction backend system may transmit, and the SVC system may receive, an indication of the transaction that was initiated using the SVC number. For example, the transaction backend system may request approval for the transaction from the SVC system.

As shown by reference number 134, the SVC system may determine whether to approve or deny the transaction based on the transaction information and the one or more parameters associated with the SVC number. For example, if the SVC number is associated with a particular transaction or a particular set of transactions, then the SVC system may determine if the transaction information indicated by the transaction backend system matches transaction information for the particular transaction or the particular set of transactions associated with the SVC number. In some implementations, the SVC system may determine whether an amount of time that the SVC number is to be valid or active (e.g., as indicated by a time limit associated with the SVC number) has expired. In some implementations, the SVC system may determine whether a transaction amount indicated by the transaction information satisfies an amount limit associated with the SVC number. In some implementations, the SVC system may determine if an entity associated with the transaction is included in a list of one or more permitted entities associated with the SVC number.

In some implementations, the SVC system may determine whether the transaction information satisfies recurrence information associated with the SVC number. For example, the recurrence information may indicate a periodicity indicating time periods during which the SVC number is valid (e.g., once a month, on the 1st of every month, and/or once a year). The SVC system may determine if a timing associated with the transaction satisfies the periodicity associated with the SVC number (e.g., the SVC system may determine whether the timing of the transaction is within a time period for which the SVC number is valid).

The SVC system may determine whether to approve or deny the transaction based on one or more (or all) of the determinations described above. As shown by reference number 136, the SVC system may transmit, and the transaction backend system may receive, an indication of an approval or a denial of the transaction. For example, if the SVC system determines that the transaction information satisfies the one or more parameters associated with the SVC number, then the SVC system may approve the transaction. Alternatively, if the SVC system determines that the transaction information does not satisfy at least one parameter associated with the SVC number, then the SVC system may deny or decline the transaction.

As shown by reference number 138, the transaction backend system may process the transaction based on the indication from the SVC system. For example, if the SVC system indicates that the transaction is approved, then the transaction backend system may proceed with processing and completing the transaction. If the SVC system indicates that the transaction is denied, then the transaction backend system may not continue to process the transaction. If the SVC system indicates that the transaction is denied, then the transaction backend system may transmit, to the first user device or another device (such as a transaction terminal), an indication that the transaction has been denied or declined.

As shown in FIG. 1D, and by reference number 140, the SVC system may process the transaction associated with the SVC number (e.g., if the transaction is approved by the SVC system). For example, as shown by reference number 142, the SVC system may settle the transaction with the entity associated with the transaction (e.g., with the transaction backend system) in a single event. For example, the SVC system may settle the transaction with the entity as one transaction by providing resources to settle the transaction (e.g., $100) and by identifying that the resources are to settle the transaction associated with the SVC number. In other words, the entity may be unaware of the accounts linked with the SVC number and may be unaware of the split of the transaction amount among the multiple accounts linked with the SVC number. Rather, the entity may view the transaction as a single transaction associated with a single payment credential (e.g., the SVC number). This may simplify the processing of the transaction between the SVC system and the transaction backend system because only a single transaction needs to be settled, rather than multiple transactions for each account linked to the SVC number.

As shown in FIG. 1D, the SVC system may charge each account linked with the SVC number for a portion of the transaction amount (e.g., as indicated by one or more parameters associated with the SVC number). For example, as shown in FIG. 1D, an Account A and an Account B may be linked with the SVC number (e.g., in a database as depicted and described in connection with FIG. 1B). As shown by reference number 144, the SVC system may perform a first action to charge the first account (e.g., the Account A) for a first portion of the transaction amount. For example, the first portion may be 50% of the transaction amount and the transaction amount may be $100.00. Therefore, the SVC system may charge the first account for $50.00 of the transaction amount. In other words, the SVC system may reduce an available balance or a credit limit of the first account by $50. Similarly, as shown by reference number 146, the second portion may also be 50% of the transaction amount. Therefore, the SVC system may charge the second account for $50.00 of the transaction amount. In other words, the SVC system may reduce an available balance or a credit limit of the second account by $50. As a result, the SVC system may be enabled to ensure that a full amount of the transaction is charged to accounts associated with the institution (e.g., the institution that provides the SVC system and the accounts).

For example, the SVC system may perform a first settlement, using resources of the first account, for the first portion of the transaction amount (e.g., $50.00). The SVC system may perform a second settlement, using resources of the second account, for the second portion of the transaction amount (e.g., $50.00). In other words, the single transaction may be completed using resources associated with the first account and resources associated with the second account. This may enable the SVC system to recoup or recover the resources for the single transaction from multiple accounts without charging any one account for the full amount of the transaction. For example, as described above, previously if a single transaction were completed, then an entire amount of the transaction would be allocated or charged to an account associated with the payment medium used to complete the transaction. The use of the SVC number may enable the SVC system to approve and/or complete a single transaction (e.g., with an entity) and allocate portions of an amount of the transaction to multiple accounts, such that a full amount of the transaction is never charged or allocated to a single account.

Additionally, the use of the SVC number may improve security for the accounts linked to the SVC number. For example, the SVC number may expire and/or may only be capable of being used in accordance with the one or more parameters associated with the SVC number. Therefore, if a fraudulent or malicious actor were to obtain the SVC number, the fraudulent or malicious actor may not be able to use the SVC number for large transactions or other transactions. Moreover, the fraudulent or malicious actor may be unable to obtain information associated with the accounts linked to the SVC number. For example, using the SVC number to complete transactions may allow users to complete transactions without providing identifying information for accounts of the users. Moreover, using the SVC number may enable a single transaction to be split amount multiple accounts without sensitive information being shared among the users and/or with a third party service or application. Rather, the SVC system may be enabled to associate a transaction, completed using the temporary credential, with the multiple accounts (e.g., without identifying information of the multiple accounts being presented at a transaction terminal), as described in more detail elsewhere herein. As a result, the use of the SVC number may improve security for the multiple accounts by reducing the number of times sensitive information (e.g., account numbers or transaction card numbers) is required to be provided to third party services or entities or other users (e.g., thereby reducing a likelihood that a fraudulent or malicious actor may obtain the account information via the third party services or entities or other users).

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a first user device 210 (e.g., which may execute a web browser 220 and a browser extension 230), a web server 240, an extension server 250, a network 260, a transaction backend system 270, an SVC system 280, and/or a second user device 290. Devices of environment 200 may interconnect via wired connections, wireless connections, or a combination of wired and wireless connections.

First user device 210 and/or second user device 290 includes a device that supports web browsing. For example, first user device 210 may include a computer (e.g., a desktop computer, a laptop computer, a tablet computer, and/or a handheld computer), a mobile phone (e.g., a smart phone), a television (e.g., a smart television), an interactive display screen, and/or a similar type of device. First user device 210 may host a web browser 220 and/or a browser extension 230 installed on and/or executing on the first user device 210.

Web browser 220 includes an application, executing on first user device 210, that supports web browsing. For example, web browser 220 may be used to access information on the World Wide Web, such as web pages, images, videos, and/or other web resources. Web browser 220 may access such web resources using a uniform resource identifier (URI), such as a URL and/or a uniform resource name (URN). Web browser 220 may enable first user device 210 to retrieve and present, for display, content of a web page.

Browser extension 230 includes an application, executing on first user device 210, capable of extending or enhancing functionality of web browser 220. For example, browser extension 230 may be a plug-in application for web browser 220. Browser extension 230 may be capable of executing one or more scripts (e.g., code, which may be written in a scripting language, such as JavaScript) to perform an operation in association with the web browser 220.

Web server 240 includes a device capable of serving web content (e.g., web documents, HTML, documents, web resources, images, style sheets, scripts, and/or text). For example, web server 240 may include a server and/or computing resources of a server, which may be included in a data center and/or a cloud computing environment. Web server 240 may process incoming network requests (e.g., from first user device 210) using hypertext transfer protocol (HTTP) and/or another protocol. Web server 240 may store, process, and/or deliver web pages to first user device 210. In some implementations, communication between web server 240 and first user device 210 may take place using HTTP.

Extension server 250 includes a device capable of communicating with first user device 210 to support operations of browser extension 230. For example, extension server 250 may store and/or process information for use by browser extension 230. As an example, extension server 250 may store a list of domains applicable to a script to be executed by browser extension 230. In some implementations, first user device 210 may obtain the list (e.g., periodically and/or based on a trigger), and may store a cached list locally on first user device 210 for use by browser extension 230.

Network 260 includes one or more wired and/or wireless networks. For example, network 260 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The transaction backend system 270 includes one or more devices capable of processing, authorizing, and/or facilitating a transaction. For example, the transaction backend system 270 may include one or more servers and/or computing hardware (e.g., in a cloud computing environment or separate from a cloud computing environment) configured to receive and/or store information associated with processing an electronic transaction. The transaction backend system 270 may process a transaction, such as to approve (e.g., permit, authorize, or the like) or decline (e.g., reject, deny, or the like) the transaction and/or to complete the transaction if the transaction is approved. The transaction backend system 270 may process the transaction based on information received from a transaction terminal, such as transaction data (e.g., information that identifies a transaction amount, a merchant, a time of a transaction, a location of the transaction, or the like), account information communicated to the transaction terminal by a transaction device (e.g., a transaction card, a mobile device executing a payment application, or the like) and/or information stored by the transaction backend system 270 (e.g., for fraud detection).

The transaction backend system 270 may be associated with a financial institution (e.g., a bank, a lender, a credit card company, or a credit union) and/or may be associated with a transaction card association that authorizes a transaction and/or facilitates a transfer of funds. For example, the transaction backend system 270 may be associated with an issuing bank associated with the transaction device, an acquiring bank (or merchant bank) associated with the merchant and/or the transaction terminal, and/or a transaction card association (e.g., VISA® or MASTERCARD®) associated with the transaction device. Based on receiving information associated with the transaction device from the transaction terminal, one or more devices of the transaction backend system 270 may communicate to authorize a transaction and/or to transfer funds from an account associated with the transaction device to an account of an entity (e.g., a merchant) associated with the transaction terminal.

The SVC system 280 includes one or more devices capable of receiving, generating, storing, processing, providing, and/or routing information associated with modifying a document object of a graphical user interface to present a temporary credential (e.g., an SVC number), as described elsewhere herein. The SVC system 280 may include a communication device and/or a computing device. For example, the SVC system 280 may include a server, such as an application server, a client server, a web server, a database server, a host server, a proxy server, a virtual server (e.g., executing on computing hardware), or a server in a cloud computing system. In some implementations, the SVC system 280 includes computing hardware used in a cloud computing environment.

The first user device 210 and/or the second user device 290 includes one or more devices capable of receiving, generating, storing, processing, and/or providing information associated with modifying a document object of a graphical user interface to present a temporary credential (e.g., an SVC number), as described elsewhere herein. The first user device 210 and/or the second user device 290 may include a communication device and/or a computing device. For example, the first user device 210 and/or the second user device 290 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the first user device 210, the web server 240, the extension server 250, the transaction backend system 270, the SVC system 280, and/or the second user device 290. In some implementations, the first user device 210, the web server 240, the extension server 250, the transaction backend system 270, the SVC system 280, and/or the second user device 290 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

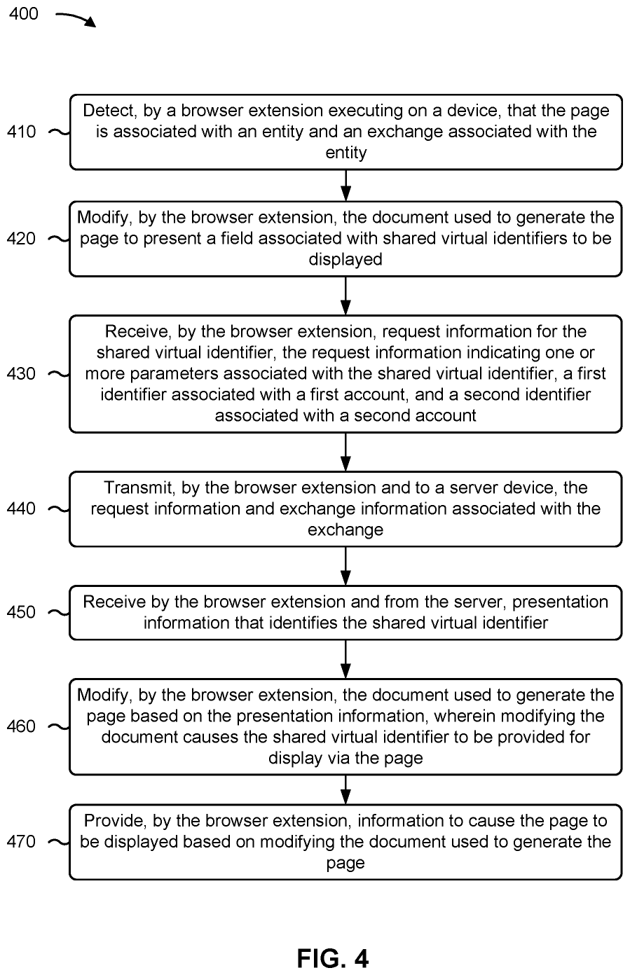

FIG. 4 is a flowchart of an example process 400 associated with modifying a document object of a graphical user interface to present a temporary credential. In some implementations, one or more process blocks of FIG. 4 may be performed by a device (e.g., the first user device 210 executing the browser extension 230). In some implementations, one or more process blocks of FIG. 4 may be performed by another device or a group of devices separate from or including the device, such as the web browser 220, the web server 240, the extension server 250, the transaction backend system 270, the SVC system 280, and/or the second user device 290. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include detecting that the page is associated with an entity and an exchange associated with the entity (block 410). As further shown in FIG. 4, process 400 may include modifying the document used to generate the page to present a field associated with shared virtual identifiers to be displayed (block 420). As further shown in FIG. 4, process 400 may include receiving request information for the shared virtual identifier, the request information indicating one or more parameters associated with the shared virtual identifier, a first identifier associated with a first account, and a second identifier associated with a second account (block 430). As further shown in FIG. 4, process 400 may include transmitting, to a server device, the request information and exchange information associated with the exchange (block 440). As further shown in FIG. 4, process 400 may include receiving, from the server, presentation information that identifies the shared virtual identifier (block 450). As further shown in FIG. 4, process 400 may include modifying the document used to generate the page based on the presentation information (block 460). In some implementations, modifying the document causes the shared virtual identifier to be provided for display via the page. As further shown in FIG. 4, process 400 may include providing information to cause the page to be displayed based on modifying the document used to generate the page (block 470).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

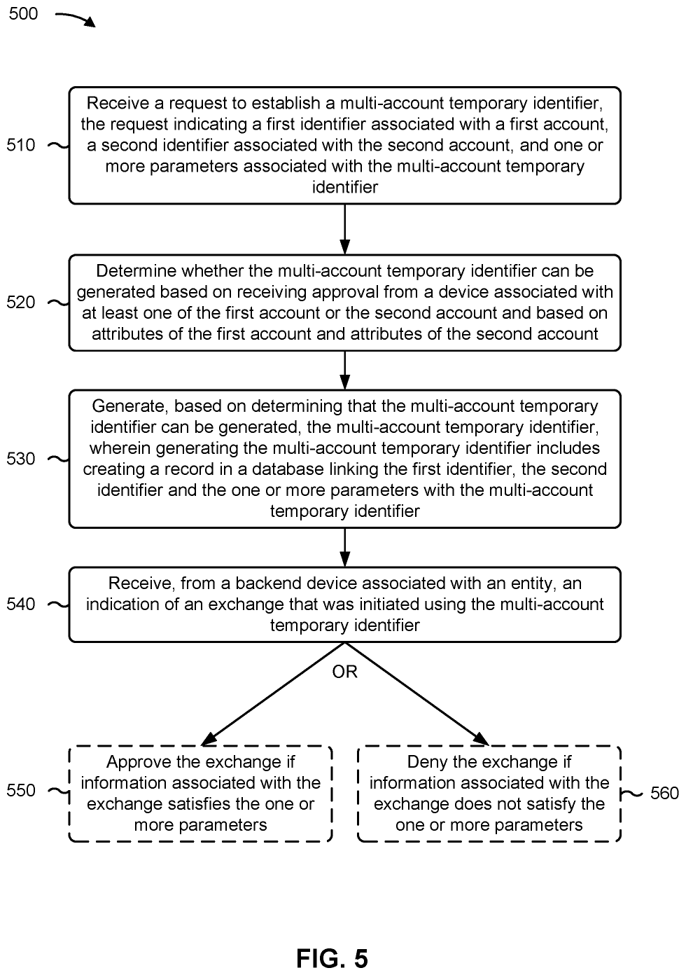

FIG. 5 is a flowchart of an example process 500 associated with generating a temporary credential for multiple accounts. In some implementations, one or more process blocks of FIG. 5 may be performed by a system (e.g., the SVC system 280). In some implementations, one or more process blocks of FIG. 5 may be performed by another device or a group of devices separate from or including the system, such as the first user device 210, the web server 240, the extension server 250, the transaction backend system 270, and/or the second user device 290. Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include receiving a request to establish a multi-account temporary identifier, the request indicating a first identifier associated with a first account, a second identifier associated with the second account, and one or more parameters associated with the multi-account temporary identifier (block 510). As further shown in FIG. 5, process 500 may include determining whether the multi-account temporary identifier can be generated based on receiving approval from a device associated with at least one of the first account or the second account and based on attributes of the first account and attributes of the second account (block 520). As further shown in FIG. 5, process 500 may include generating, based on determining that the multi-account temporary identifier can be generated, the multi-account temporary identifier (block 530). In some implementations, generating the multi-account temporary identifier includes creating a record in a database linking the first identifier, the second identifier, and the one or more parameters with the multi-account temporary identifier. As further shown in FIG. 5, process 500 may include receiving, from a backend device associated with an entity, an indication of an exchange that was initiated using the multi-account temporary identifier (block 540). As further shown in FIG. 5, process 500 may include approving the exchange if information associated with the exchange satisfies the one or more parameters (block 550). Alternatively, process 500 may include denying the exchange if information associated with the exchange does not satisfy the one or more parameters (block 560).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Accordingly, the scope of the invention should be determined not by the embodiments illustrated, but by the appended claims and their equivalents.

What is claimed is:

1. A non-transitory computer-readable medium storing a set of instructions for modifying a document object of a user interface to present a temporary credential, the set of instructions comprising:
one or more instructions that, when executed by one or more processors of a device, cause the device to:
identify, based on information to be displayed by the user interface of the device, first information associated with an exchange, wherein the first information indicates an amount associated with the exchange and an entity associated with the exchange;
modify the document object of the user interface to cause a temporary credential request field to be presented for display by the user interface, wherein the temporary credential request field indicates the first information and one or more fields for inputting account identifiers;
receive, via an input to the temporary credential request field, a request to generate the temporary credential for the exchange, wherein the request indicates that the temporary credential is to be associated with a first account and a second account, and wherein the request indicates a first portion of the amount to be associated with the first account and a second portion of the amount to be associated with the second account;
transmit, to a server device, second information associated with the request, wherein the second information indicates a first identifier of the first account, a second identifier of the second account, and the first information associated with the exchange;
receive, from the server device, presentation information that indicates the temporary credential;
modify the document object of the user interface based on the presentation information to cause an indication of the temporary credential to be provided for presentation via the user interface; and
provide the user interface for presentation by the device based on modifying the document object.

2. The non-transitory computer-readable medium of claim 1, wherein the one or more instructions, when executed by the one or more processors, further cause the device to:
receive, via the user interface, a request to initiate the exchange using the temporary credential; and
transmit, to a backend device, third information that indicates the temporary credential and the first information associated with the exchange, wherein the exchange is completed using resources associated with the first account based on the first portion and resources associated with the second account based on the second portion.

3. The non-transitory computer-readable medium of claim 1, wherein the one or more instructions, that cause the device to receive the request to generate the temporary credential for the exchange, cause the device to:
receive one or more parameters associated with the request, the one or more parameters associated with one or more limitations to be associated with the temporary credential, wherein the one or more parameters include at least one of:
an amount of time that the temporary credential is to be valid,
one or more permitted entities associated with the temporary credential,
whether the temporary credential is capable of being used to complete exchanges other than the exchange, or
recurrence information associated with the temporary credential.

4. The non-transitory computer-readable medium of claim 1, wherein receiving the presentation information that indicates the temporary credential is based on the server device obtaining approval to generate the temporary credential.

5. The non-transitory computer-readable medium of claim 1, wherein the temporary credential is specific to the exchange and the entity, and wherein the temporary credential enables the exchange to be associated with the first account and the second account.

6. The non-transitory computer-readable medium of claim 1, wherein the one or more instructions, when executed by the one or more processors, further cause the device to:
detect, based on information to be displayed by the user interface of the device and after receiving the presentation information, a modification associated with the exchange from the first information to fourth information, wherein the fourth information indicates a modified amount associated with the exchange; and
modify the document object of the user interface to prevent the temporary credential from being used for the exchange based on detecting the modification.

7. A method of modifying a document used to generate a page to cause a shared virtual identifier to be presented for display by a device, comprising:
detecting, by a browser extension executing on the device, that the page is associated with an entity and an exchange associated with the entity;
modifying, by the browser extension, the document used to generate the page to present a field associated with shared virtual identifiers to be displayed;
receiving, by the browser extension, request information for the shared virtual identifier, the request information indicating one or more parameters associated with the shared virtual identifier, a first identifier associated with a first account, and a second identifier associated with a second account;
transmitting, by the browser extension and to a server device, the request information and exchange information associated with the exchange;
receiving, by the browser extension and from the server, presentation information that identifies the shared virtual identifier;
modifying, by the browser extension, the document used to generate the page based on the presentation information, wherein modifying the document causes the shared virtual identifier to be provided for display via the page; and
providing, by the browser extension, information to cause the page to be displayed based on modifying the document used to generate the page.

8. The method of claim 7, further comprising:
receiving a request to initiate the exchange using the shared virtual identifier; and
transmitting, to a backend device, an indication of the shared virtual identifier and the exchange information to enable the exchange to be completed using resources of the first account and resources of the second account.

9. The method of claim 7, wherein the one or more parameters include at least one of:
a split between the first account and the second account for the shared virtual identifier,
an amount of time that the shared virtual identifier is to be valid,
one or more permitted entities associated with the shared virtual identifier,
an indication of whether the shared virtual identifier is capable of being used to complete exchanges other than the exchange, or
recurrence information associated with the shared virtual identifier.

10. The method of claim 7, wherein the shared virtual identifier is specific to the exchange and the entity, and wherein the shared virtual identifier enables the exchange to be associated with the first account and the second account.

11. The method of claim 7, further comprising:
detecting, based on information to be displayed by the page and after receiving the presentation information, a modification associated with the exchange; and
performing, by the device, an action to prevent the shared virtual identifier from being used for the exchange based on detecting the modification.

12. A system for generating multiple account (multi-account) temporary identifiers to enable an exchange to be associated with multiple accounts, the system comprising:
one or more memories; and
one or more processors, coupled to the one or more memories, configured to:
receive a request to establish a multi-account temporary identifier, the request indicating a first identifier associated with a first account, a second identifier associated with the second account, and one or more parameters associated with the multi-account temporary identifier;
determine whether the multi-account temporary identifier can be generated based on receiving approval from a device associated with at least one of the first account or the second account and based on attributes of the first account and attributes of the second account;
generate, based on determining that the multi-account temporary identifier can be generated, the multi-account temporary identifier, wherein generating the multi-account temporary identifier includes creating a record in a database linking the first identifier, the second identifier, and the one or more parameters with the multi-account temporary identifier;
receive, from a backend device associated with an entity, an indication of an exchange that was initiated using the multi-account temporary identifier; and
approve the exchange if information associated with the exchange satisfies the one or more parameters, or
deny the exchange if information associated with the exchange does not satisfy the one or more parameters.

13. The system of claim 12, wherein the one or more parameters include at least one of:
a split between the first account and the second account for the multi-account temporary identifier,
an amount limit associated with the multi-account temporary identifier,
an amount of time that the multi-account temporary identifier is to be valid,
one or more permitted entities associated with the multi-account temporary identifier,
an indication of whether the multi-account temporary identifier is capable of being used to complete exchanges other than the exchange, or
recurrence information associated with the multi-account temporary identifier.

14. The system of the claim 13, wherein the recurrence information indicates at least one of:
an entity associated with the multi-account temporary identifier,
an amount associated with the multi-account temporary identifier, or
a periodicity indicating time periods during which the multi-account temporary identifier is valid.

15. The system of claim 12, wherein the one or more processors, to approve the exchange if information associated with the exchange satisfies the one or more parameters, are configured to:
perform a first settlement with the backend device associated with the entity for an amount of the exchange;
perform a second settlement, using resources of the first account, for a first portion of the amount of the exchange based on a split indicated by the one or more parameters, wherein the split indicates a portioning of resources between the first account and the second account for exchanges completed via the multi-account temporary identifier; and
perform a third settlement, using resources of the second account, for a second portion of the amount of the exchange based on the split indicated by the one or more parameters,
wherein the first settlement, the second settlement, and the third settlement are associated with the multi-account temporary identifier.

16. The system of claim 12, wherein the one or more processors, to approve the exchange if information associated with the exchange satisfies the one or more parameters, are configured to:
update a first balance associated with the first account based on a first portion of an amount of the exchange based on a split indicated by the one or more parameters; and
update a second balance associated with the second account based on a second portion of the amount of the exchange based on the split indicated by the one or more parameters.

17. The system of claim 12, wherein the one or more processors are further configured to:
transmit, to a device associated with the first account, presentation information indicating the multi-account temporary identifier to cause the multi-account temporary identifier to be presented for display by the device.

18. The system of claim 12, wherein the one or more processors are further configured to:
determine whether to approve or deny the exchange based on determining at least one of:
whether an amount of the exchange satisfies an amount limit associated with the multi-account temporary identifier,
whether the entity associated with the exchange is included in one or more permitted entities associated with the multi-account temporary identifier,
whether the exchange is a same exchange indicated in the request to establish a multi-account temporary identifier,
whether an amount of time that the multi-account temporary identifier is to be valid has expired, or
whether a timing of the exchange satisfies recurrence information associated with the multi-account temporary identifier.

19. The system of claim 12, wherein the one or more processors, to generate the multi-account temporary identifier, are configured to:
reduce a spending limit associated with the first account by a first portion of an amount limit associated with the multi-account temporary identifier indicated by the one or more parameters; and
reduce a spending limit associated with the second account by a second portion of the amount limit associated with the multi-account temporary identifier.

20. The system of claim 12, wherein the one or more processors, to determine whether the multi-account temporary identifier can be generated, are configured to:
transmit, to the device associated with at least one of the first account or the second account, a request for approval to generate the multi-account temporary identifier, wherein the request for approval indicates an identifier associated with the first account and the one or more parameters; and
receive, from the device, an indication of approval to generate the multi-account temporary identifier.
